(19) United States
(12) Patent Application Publication
(10) Pub. No.: US 2026/0005903 A1
(43) Pub. Date: Jan. 1, 2026

(54) DEMODULATION METHOD OF DPSK SIGNALS, DEMODULATION SYSTEM, AND COMMUNICATION DEVICE THEREOF

(71) Applicant: JADARD TECHNOLOGY INC., SHENZHEN (CN)

(72) Inventors: TUO-YU YAO, Hsinchu (TW); YU-CHIEH HSU, Tainan (TW)

(21) Appl. No.: 19/188,714

(22) Filed: Apr. 24, 2025

(30) Foreign Application Priority Data
Jun. 29, 2024 (CN) 202410869855.1

(51) Int. Cl. H04L 27/233; H04L 27/20

(52) U.S. Cl. CPC H04L 27/233; H04L 27/2071

(57) ABSTRACT

A demodulation method of differential phase shift keying (DPSK) signals includes receiving a modulation signal using a phase extraction circuitry. A plurality of signal points is acquired, which is constructed by phase values of point positions of the modulation signal. A demodulation value of the current signal point is acquired according to the current signal point, the previous signal point, and a predefined demodulation algorithm. A demodulation signal is acquired according to the demodulation values corresponding to the signal points. A demodulation system and a communication device are also provided.

### TECHNICAL FIELD

The present application generally relates to communication technology, and particularly to a demodulation method of differential phase shift keying (DPSK) signals, a demodulation system, and a communication device thereof.

### BACKGROUND

In a related art, a demodulation circuitry of differential phase shift keying (DPSK) signals uses a loop filter and a voltage-controlled oscillator for demodulating, thus inputted modulation signal and original coordinate system in remodulating process remain orthogonal, and four phase angles of the DPSK signals are simply determined.

However, the demodulation circuitry with the loop filter and the voltage-controlled oscillator are complex and requires a large number of hardware components, thus a cost of a demodulation system is high.

There is room for improvement in the art.

### BRIEF DESCRIPTION OF THE DRAWINGS

Implementations of the present application will now be described, by way of example only, with reference to the attached figures.

FIG. 1 is a diagram illustrating an embodiment of a demodulation system according to the present application, the demodulation system includes a phase extraction circuitry.

FIG. 2 is a diagram illustrating an embodiment of a phase extraction circuitry of FIG. 1 according to the present application.

FIG. 3 is a flowchart illustrating an embodiment of a demodulation method of differential phase shift keying (DPSK) signals according to the present application.

FIG. 4 is a flowchart illustrating an embodiment of a first predefined demodulation algorithm according to the present application.

FIG. 5 is a diagram illustrating an embodiment of a pervious signal point P0 in an original coordinate system IQ according to the present application.

FIG. 6 is a diagram illustrating an embodiment of a new coordinate system I′Q′ according to the present application.

FIG. 7 is a diagram illustrating an embodiment of a current signal point P1 in the new coordinate system I′Q′ of FIG. 6 according to the present application.

FIG. 8 is a detail flowchart illustrating an embodiment of block S44 of FIG. 4 according to the present application.

FIG. 9 is a flowchart illustrating an embodiment of a second predefined demodulation algorithm according to the present application.

FIG. 10 is a diagram illustrating an embodiment of four reference points according to the present application.

FIG. 11 is a diagram illustrating an embodiment of a third predefined demodulation algorithm according to the present application.

FIG. 12 is a diagram illustrating an embodiment of a fourth predefined demodulation algorithm according to the present application.

### DETAILED DESCRIPTION

It should be understood that, the term “at least one” of the present application means one or multiple. The term “multiple” means two or more. The term “multiple” means two or more. The term “and/or” of the present application merely describes associations between associated objects, and it indicates three types of relationships. For example, “A and/or B” may indicate A alone, A and B, or B alone. “A” and “B” may be singular or plural, respectively. In the description of the present application, the terms such as “first”, or “second”, “third”, “fourth” (if exist), and the like are used only to distinguish between different objects, and are not to be understood as indicating or implying a relative importance or implicitly specifying the number, particular order, or primary and secondary relation of the technical features indicated.

In addition, it should be noted that the methods disclosed in the embodiments of the present disclosure or the methods shown in the flowcharts include one or more blocks for implementing the methods, and the one or more blocks are not deviated from the scope of the claims. The order of execution can be interchanged with each other, and some of the one or more blocks can also be deleted.

In a related art, a demodulation circuitry of differential phase shift keying (DPSK) signals uses a loop filter and a voltage-controlled oscillator for demodulating, thus inputted modulation signal and original coordinate system in remodulating process remain orthogonal, and four phase angles of the DPSK signals are simply determined.

However, the demodulation circuitry with the loop filter and the voltage-controlled oscillator are complex and requires a large number of hardware components, thus a cost of a demodulation system is high.

The present application provides a demodulation method of DPSK signals, a demodulation system, and a communication device thereof. The four phase angles of the DPSK signals are simply determined without remaining the inputted modulation signal and original coordinate system to be orthogonal. Therefore, a complexity of the demodulation circuitry is reduced, and a cost of the demodulation system is also reduced.

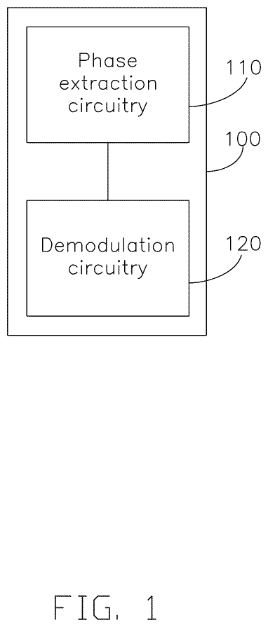

Referring to FIG. 1, FIG. 1 shows the demodulation system 100 of the DPSK signals according to the present application. The demodulation system 100 includes a phase extraction circuitry 110 and a demodulation circuitry 120.

In one embodiment, the phase extraction circuitry 110 is configured to receive a modulation signal and outputs a plurality of signal points. The signal points are constructed by different phase values of in different points positions of the modulation signal. The demodulation circuitry 120 is configured to execute any one of following demodulation methods. The demodulation circuitry 120 may be installed in a processor of an electronic device. One or more application programs may be stored in a storage medium of the electronic device, and be configured to be executed by the processor, the one or more application programs served as the demodulation circuitry 120 may be configured to execute the following demodulation method. In some embodiments, the phase extraction circuitry 110 includes a Goertzel filter circuitry.

As an example, the storage medium is configured to store program codes and various data. The storage medium may include a Read-Only Memory (ROM), a Random Access Memory (RAM), a Programmable Read-Only Memory (PRAM), a Erasable Programmable Read-Only Memory (EPROM), a One-time Programmable Read-Only Memory (OTPROM), an Electrically-Erasable Programmable Read-Only Memory (EEPROM), a Compact Disc Read-Only Memory (CD-ROM), or other optical disc memories, optical disc memories, a magnetic disk storage medium or other magnetic storage devices, or any other computer-readable medium that can be used to carry or store data. The processor may include an integrated circuit. For example, the processor may include a single packaged integrated circuit, or may include a plurality of packaged integrated circuits that have a same function or different functions, including one or more central processing units (central processing units, CPUs), a microprocessor, a digital processing chip, a graphics processing unit, and a combination of various control chips. The processor is a control unit (Control Unit) of the electronic device, and executes various functions of the electronic device and performs data processing by running or executing a program or a module stored in the storage medium and invoking data stored in the storage medium.

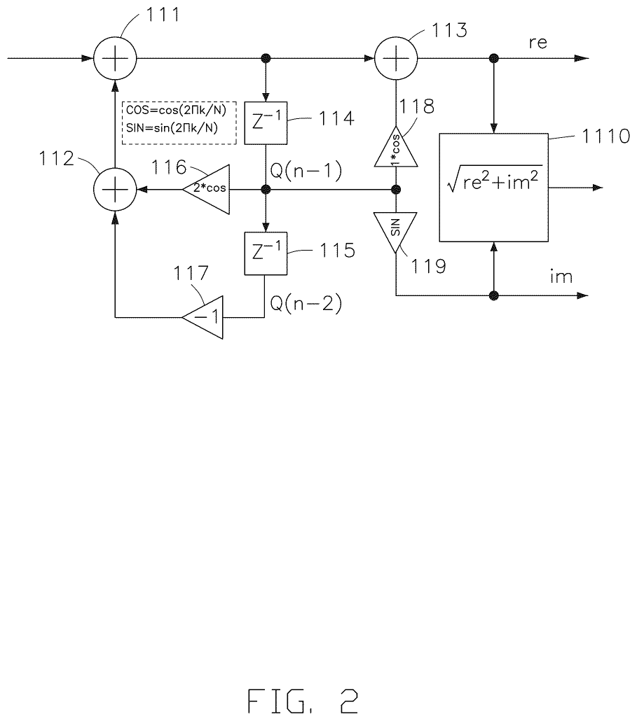

In some embodiments, as shown in FIG. 2, the phase extraction circuitry 110 includes a first adder 111, a second adder 112, a third adder 113, a first delayer 114, a second delayer 115, a first amplifier 116, a second amplifier 117, a third amplifier 118, a fourth amplifier 119, and a logic-arithmetic unit 1110.

A first terminal of the first adder 111 is configured to receive the modulation signal, and a second terminal of the first adder 11 is electrically connected with a first terminal of the first delayer 114. A second terminal of the first delayer 114 is electrically connected with an input terminal of the first amplifier 116. An output terminal of the first amplifier 116 is electrically connected with a first terminal of the second adder 112. A second terminal of the second adder 112 is electrically connected with a third terminal of the first adder 111. A first terminal of the second delayer 115 is electrically connected with the second terminal of the first delayer 114, and a second terminal of the second delayer 115 is electrically connected with a third terminal of the second adder 112.

The second terminal of the first adder 111 is also electrically connected with a first terminal of the third adder 113. A second terminal of the third adder 113 is configured to output a first coordinate value of a signal point, such as the value on an I axis in the original coordinate system. An input terminal of the second amplifier 117 is electrically connected with the output terminal of the first delayer 114. An output terminal of the second amplifier 117 is electrically connected with a third terminal of the third adder 113. An input terminal of the third amplifier 118 is electrically connected with the output terminal of the delayer 114. An output terminal of the third adder 114 is configured to output a second coordinate value, such as the value on an Q axis in the original coordinate system. A first input terminal of the logic-arithmetic unit 1110 is configured to receive the first coordinate value, and a second terminal of the logic-arithmetic unit 1110 is configured to receive the second coordinate value.

In one embodiment, both of the first delayer 114 and the second delayer 115 are configured to delay a sampling period. A magnification times of the first amplifier 116 is

$$2 cos ( \frac{2 π k}{N} ) .$$

N represents a number of sampling value in a detection segment of the phase extraction circuitry 110, k represents a number of a complete period including a target frequency in the detection segment of the phase extraction circuitry 110. A magnification times of the second amplifier 117 is −1. A magnification times of the third amplifier 118 is

$$- cos ( \frac{2 π k}{N} ) .$$

A magnification times of the fourth amplifier 118 is

$$sin ( \frac{2 π k}{N} ) .$$

A run algorithm of the logic-arithmetic unit 1110 is \sqrt{re²+im²}, re represents the first coordinate value of the signal point, and im represents the second coordinate value of the signal point.

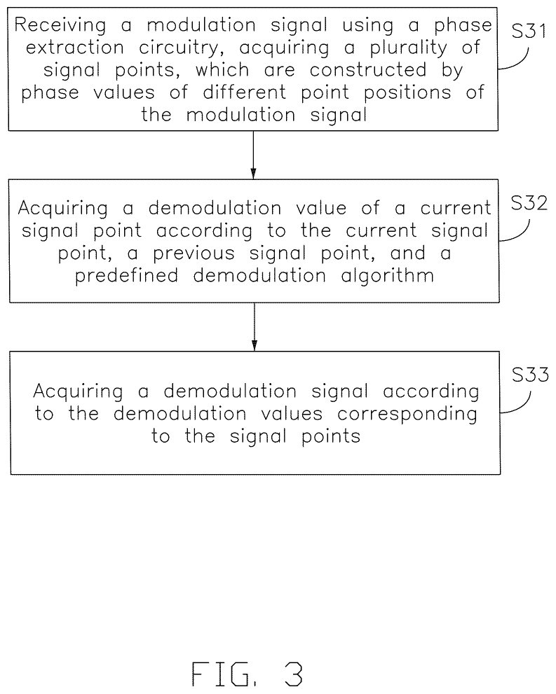

The following describes embodiments of a demodulation method of the DPSK signals of the present application in more detail with reference to the FIG. 3. FIG. 3 shows a flowchart of demodulation method of the DPSK signals of the present application. The display driving method includes the following steps.

In block S31, a modulation signal is received by the phase extraction circuitry 110, a plurality of signal points is acquired, which are constructed according to the phase values of different point positions of the modulation signal.

It is understood that, the DPSK may be differential binary phase shift keying (DBPSK) or differential quadrature reference phase shift keying (DQPSK). The DBPSK needs to analysis that whether an angle between a current signal point and a previous signal point is 0 degrees or 180 degrees, and corresponding demodulation signal are acquired. The DQPSK needs to analysis that whether an angle between the current signal point and the previous signal point is 0 degrees, 90 degrees, 180 degrees, or 270 degrees, and corresponding demodulation signal are acquired.

In block S32, a demodulation value of the current signal point is acquired according to the current signal point, the previous signal point, and a predefined demodulation algorithm.

In one embodiment, after receiving the current signal point, the demodulation circuitry 120 acquires the demodulation value of the current signal point according to the current signal point, the previous signal point, and the predefined demodulation algorithm. For example, when the modulation signal is the DBPSK signal, the angle is determined to be 0 degrees or 180 degrees by the current signal point, the previous signal point, and the predefined demodulation algorithm, and the demodulation signal corresponding to 0 degrees or 180 degrees.

In block S33, a demodulation signal is acquired according to the demodulation values corresponding to the signal points.

In one embodiment, after acquiring the demodulation values corresponding to the signal points, the demodulation circuitry 120 obtains continuous signals according to the demodulation values. Otherwise, the demodulation circuitry 120 may also output the acquired demodulation values, and a following circuitry may reconstruct the demodulation values to obtain the demodulation signals.

It is understood that, the embodiment of the present application uses the phase extraction circuitry 110 to acquire signal points according to the phase values of the point positions in the modulation signal, acquire a demodulation value of the current signal point according to two continuous signal points, therefore the input modulation signal and the original coordinate system does not need to be orthogonal while a demodulation process, and phase angles of the DPSK also be determined. Thus, a complexity of the demodulation circuitry 120 is reduced, and a cost of the demodulation system is also reduced.

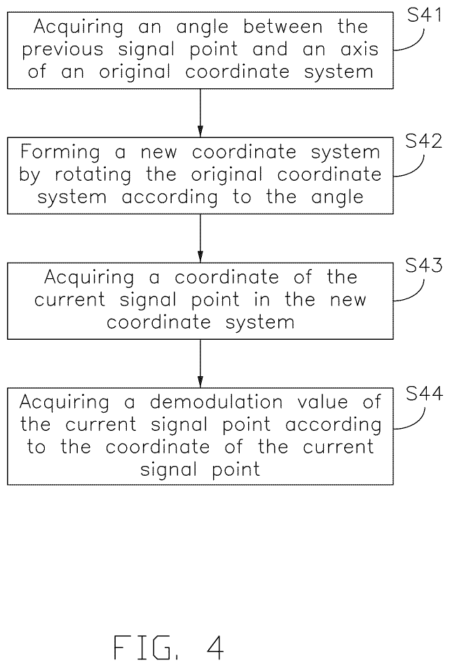

Referring to FIG. 4, FIG. 4 shows a flowchart of a first predefined demodulation algorithm provided by the present application, which includes the following steps.

In block S41, an angle between the previous signal point and an axis of an original coordinate system.

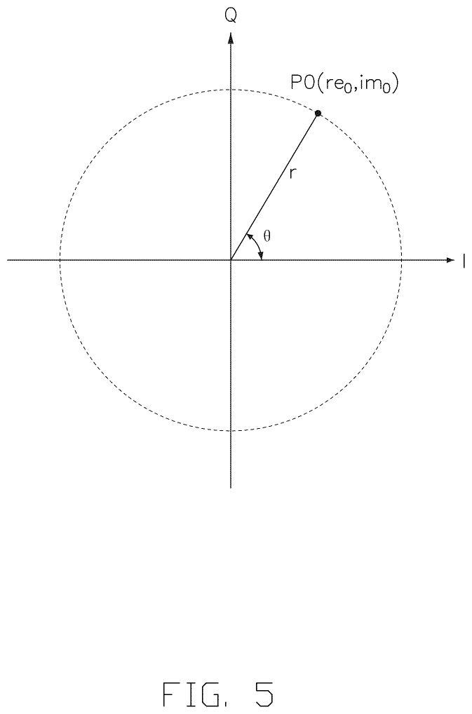

In one embodiment, as shown in FIG. 5, the demodulation circuitry 120 may acquire the angle θ between the previous signal point P0(re₀, im₀) and an axis of the original IQ coordinate system. In some embodiments, the step of acquiring the angle between the previous signal point and the axis of the original IQ coordinate system includes acquiring the angle θ between the previous signal point and an I axis in the original IQ coordinate system. The coordinate of the current signal point represents as P1(re₁, im₁).

In block S42, a new coordinate system is formed by rotating the original coordinate system according to the angle.

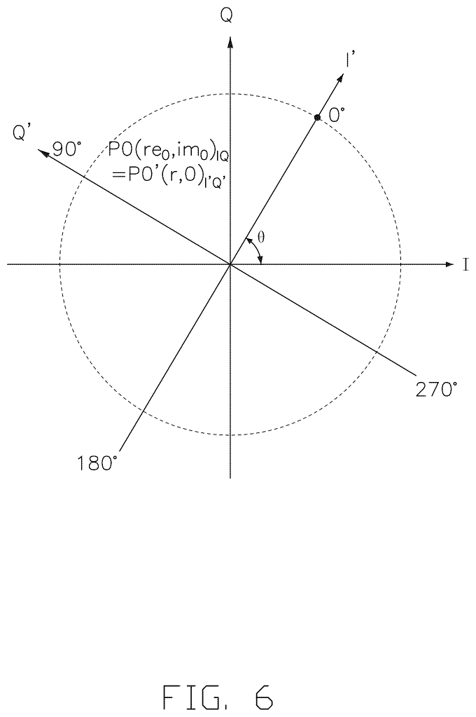

In one embodiment, as shown in FIG. 6, the demodulation circuitry 120 rotates the original coordinate system in related to the angle to form the new coordinate system I′Q′. In some embodiments, the step of forming the new coordinate system I′Q′ by rotating the original coordinate system in related to the angle includes: rotating the original coordinate system IQ according to the angle to form the new coordinate system I′Q′, and the previous signal point is located on a new axis I′ of the new coordinate system I′Q′.

In block S43, a coordinate of the current signal point in the new coordinate system are acquired.

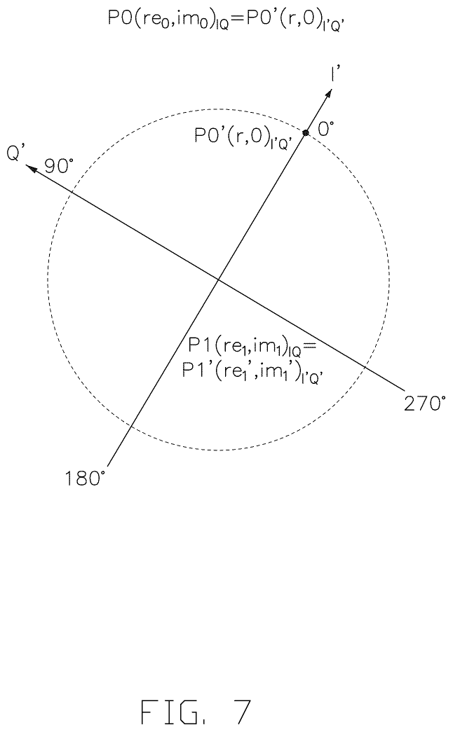

In one embodiment, as shown in FIG. 7, after rotating, the coordinate of the previous signal point in the new coordinate system represents as P₀′(re₀′, im₀′), and the current signal point in the new coordinate system represents as P1′(re₁′, im₁′). The coordinate of the current signal point in the new coordination system P1′(re₁′, im₁′) may be acquired by the following formular.

$${[ \begin{matrix}{re}^{′} \\ {im}^{′}\end{matrix} ]}_{I ′ Q ′} = {[ \begin{matrix}cos θ & sin θ \\ - sin θ & cos θ\end{matrix} ] [ \begin{matrix}re \\ im\end{matrix} ]}_{IQ}$$

Wherein, cos θ=re₀/r, sin θ=im₀/r, represent a distance between the previous signal point P0(re₀, im₀) and an original point of the original IQ coordinate system.

In block S44, the demodulation value of the current signal point is acquired based on the coordinates of the current signal point in the new coordinate system.

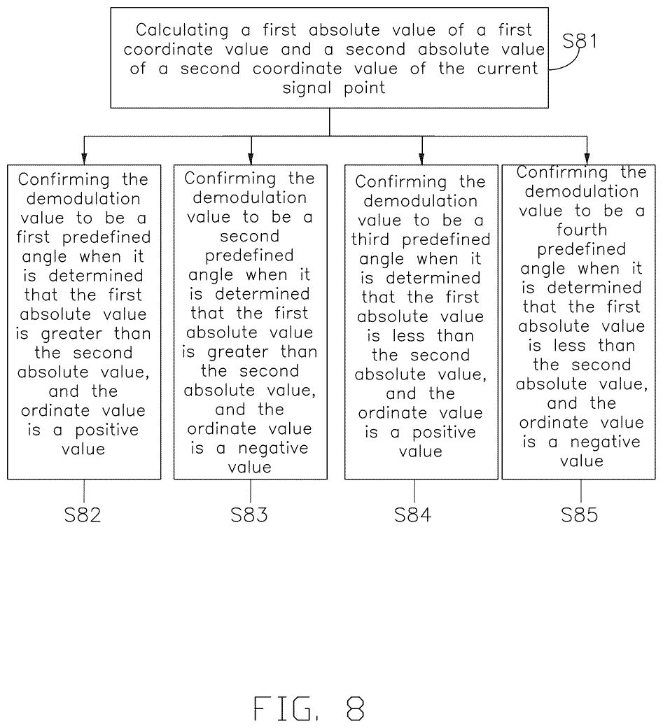

As shown in FIG. 8, the block S44 further includes the following steps.

In blocks S81, a first absolute value of a first coordinate value and a second absolute value of the second coordinate value of the current signal point.

In blocks S82, the demodulation value is confirmed to be a first predefined angle when it is determined that the first absolute value is greater than the second absolute value, and the second coordinate value is a positive value.

In blocks S83, the demodulation value is confirmed to be a second predefined angle when it is determined that the first absolute value is greater than the second absolute value, and the second coordinate value is a negative value.

In blocks S84, the demodulation value is confirmed to be a third predefined angle when it is determined that the first absolute value is less than the second absolute value, and the second coordinate value is a positive value.

In blocks S85, the demodulation value is confirmed to be a fourth predefined angle when it is determined that the first absolute value is less than the second absolute value, and the second coordinate value is a negative value.

In one embodiment, as shown in FIG. 7, using the current signal point is P1′(re₁′, im₁′) as an example, when the |re′|>|im′|, and re′ is a positive number, it is determined that the angle θ is 0 degrees. When the |re′|>|im′|, and re′ is a negative number, it is determined that the angle θ is 180 degrees. When the |re′|<|im′|, and re′ is a positive number, it is determined that the angle θ is 90 degrees. When the |re′|<|im′|, and re′ is a negative number, it is determined that the angle θ is 270 degrees.

In some embodiments, when the angle θ is 0 degrees, the demodulation value is determined to be a first predefined value. When the angle θ is 180 degrees, the demodulation value is determined to be a second predefined value. When the angle θ is 90 degrees, the demodulation value is determined to be a third predefined value. When the angle θ is 270 degrees, the demodulation value is determined to be a fourth predefined value

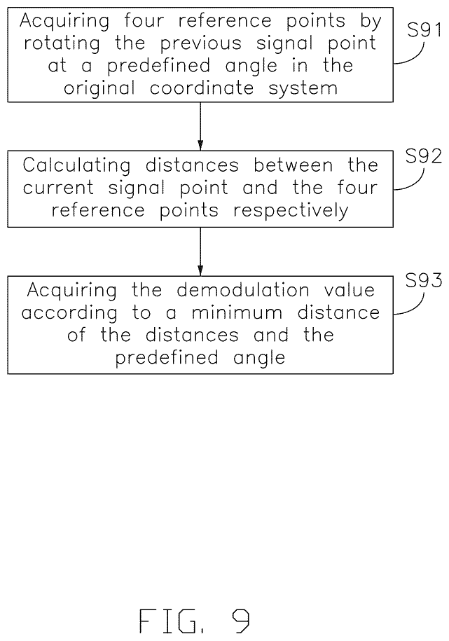

Referring to FIG. 9, FIG. 9 shows a flowchart of a second predefined demodulation algorithm provided by the present application, which includes the following steps.

In block S91, four reference points are acquired by rotating the previous signal point at a predefined angle in the original coordinate system.

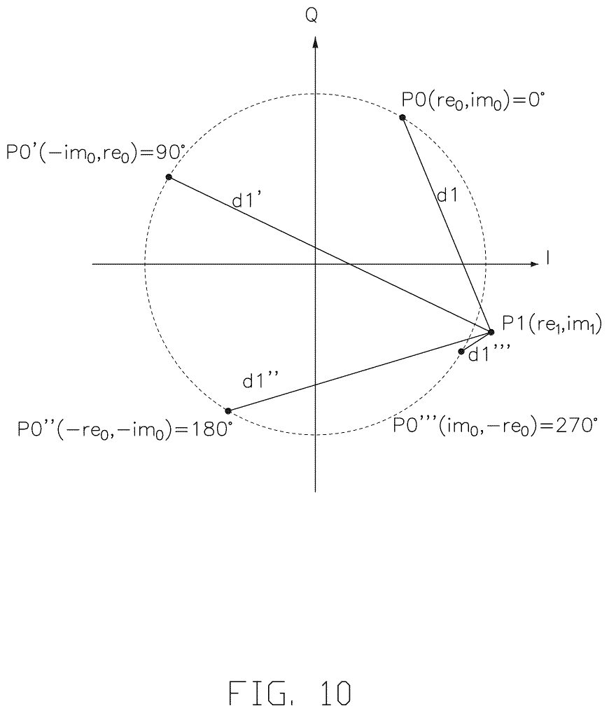

In one embodiment, as shown in FIG. 10, when the predefined angle is 90 degrees, the demodulation circuitry 120 rotates previous signal point in the original coordinate system to form the four reference points, which are P0(re₀, im₀) representing 0 degrees, P0′(−im₀, re₀) representing 90 degrees, P0″(−re₀, −im₀) representing 180 degrees, and P0″(im₀, −re₀) representing 270 degrees.

In block S92, distances between the current signal point and the four reference points are calculated respectively.

In block S93, the demodulation value is acquired according to a minimum distance of the distances and the predefined angle.

It is understood that, there are four distances d1, d2, d3, d4 between the current signal point P1(re₁, im₁) and the four reference points. When the distance d1 is a minimum distance, it represents that the current signal point P1(re₁, im₁) is closes to the reference point P0′(−im₀, re₀), and the current signal point P1(re₁, im₁) rotates 90 degrees in related to the previous signal point. Therefore, the angle between the current signal point P1(re₁, im₁) and the previous signal point P0(re₀, im₀) is 90 degrees, and the predefined value corresponding to the angle at 90 degrees serves as the demodulation value.

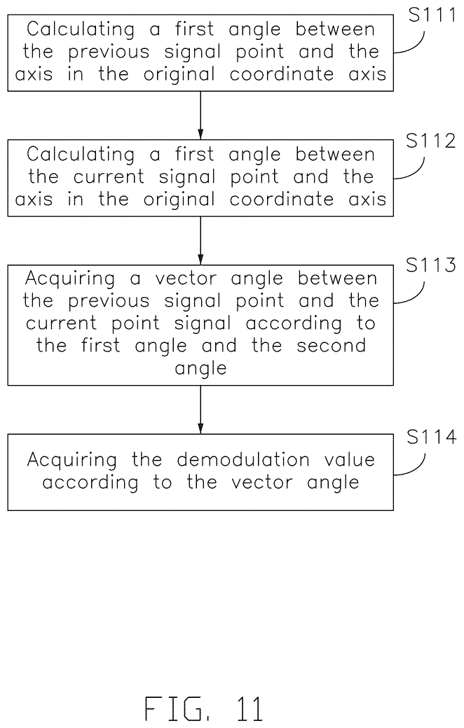

Referring to FIG. 11, FIG. 11 shows a flowchart of a third predefined demodulation algorithm provided by the present application, which includes the following steps.

In block S111, a first angle between the previous signal point and the axis in the original coordinate axis is calculated.

In block S112, a second angle between the current signal point and the axis in the original coordinate axis is calculated.

In block S113, a vector angle between the previous signal point and the current point signal are acquired according to the first angle and the second angle.

In block S114, the demodulation value is acquired according to the vector angle.

In one embodiment, the angle θ of the signal point related to the original coordinate axis may be calculated using a function of tan⁻¹(im/re) to perform Taylor Expansions, which is

$${tan}^{- 1} ( x ) = x - \frac{{x}^{2}}{3} + \frac{{x}^{3}}{5} - \frac{{x}^{7}}{7} … ( x = im / re ) ,$$

but not being limited.

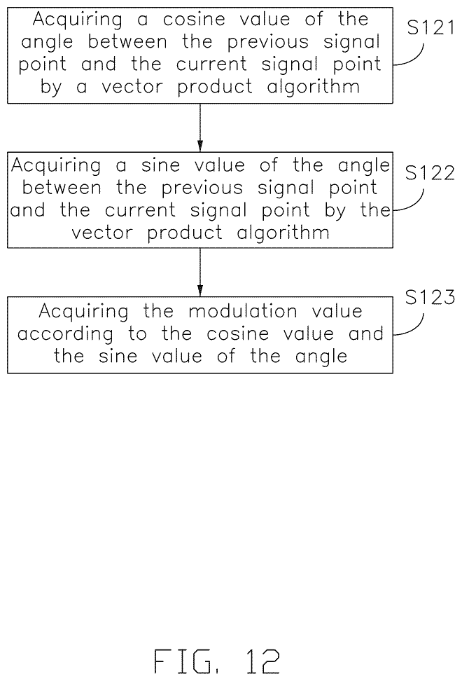

Referring to FIG. 12, FIG. 12 shows a flowchart of a fourth predefined demodulation algorithm provided by the present application, which includes the following steps.

In block S121, a cosine value of the vector angle between the current signal point and the previous signal point is acquired according to a vector product algorithm.

In one embodiment, the previous signal point is P0(re₀, im₀), the current signal point is P1(re₁, im₁), a cosine value of the angle is cos θ, the dot product algorithm is |P0|·|P1| cos θ=re₀×im₁−re₁×im₀.

In block S122, a sine value of the vector angle between the current signal point and the previous signal point is acquired according to the vector product algorithm.

In one embodiment, the previous signal point is P0(re₀, im₀), the current signal point is P1(re₁, im₁), a sine value of the angle is sin θ, the dot product algorithm is |P0|·|P1| sin θ=re₀×re₁−im₀×im₁.

In block S123, the demodulation value is acquired according to the cosine value and the sine value.

In one embodiment, when cos θ=1, and sin θ=0, the angle θ is 0 degrees. When cos θ=0, and sin θ=1, the angle θ is 90 degrees. When cos θ=−1, and sin θ=0, the angle θ is 0 degrees. When cos θ=0, and sin θ=−1, the angle θ is 270 degrees.

In some embodiments, when the angle θ is 0 degrees, the demodulation value is determined to be the first predefined value. When the angle θ is 180 degrees, the demodulation value is determined to be the second predefined value. When the angle θ is 90 degrees, the demodulation value is determined to be the third predefined value. When the angle θ is 270 degrees, the demodulation value is determined to be the fourth predefined value.

The present application also provides a communication device, includes the demodulation system of the DPSK signals of the foregoing embodiments.

In one embodiment, the beneficial effect of the communication device of the present disclosure can refer to the detailed description of the foregoing demodulation method of the DPSK signals. Details are not described herein again.

The present application also provides a computer readable storage medium. The computer readable storage medium stores computer programs or codes, when being executed to perform the foregoing demodulation method of the DPSK signals.

The above embodiments may be fully or partially implemented through software, hardware, firmware or any combination thereof. When the embodiments are fully or partially implemented in the form of a computer program product, the computer program product includes one or more computer instructions. When the computer program instructions are loaded or executed on the computer, the process or function described in accordance with the embodiments of the present application is fully or partially generated. The computer may be a general purpose computer, a special purpose computer, a computer network, or other programmable device. The computer instructions can be stored in a computer readable storage medium, or transmit from a computer readable storage medium to another computer readable storage medium. For example, the computer instructions can be transmitted from a web site, computer, server, or data center through the cable (such as a coaxial cable, optical fiber, digital subscriber line (DSL)) or wireless (such as infrared, radio, microwave, etc.) to another web site, computer, server, or data center. The computer readable storage medium may be any available medium that the computer can access, or a data storage device that contains a server, a data center and the like that is integrated by one or more available medias. The available media may be magnetic media (for example, floppy disk, hard disk, magnetic tape), optical media (for example, DVD), or semiconductor media (for example, Solid State Disk (SSD)).

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium includes: any medium that can store program code, such as a ROM, a RAM, a magnetic disk, or an optical disc. If there is no conflict, the technical features in embodiments and implementations of this application may be randomly combined.

Those skilled in the art will recognize that the above described embodiments are only intended to illustrate the invention and are not intended to limit the invention, and numerous possible modifications and variations within the spirit of the invention will fall within the scope of the invention.

What is claimed is:

1. A demodulation method of differential phase shift keying (DPSK) signals, applied in a communication device, the communication device comprising a phase extraction circuitry and a demodulation circuitry, the demodulation method comprising:
receiving a modulation signal using a phase extraction circuitry, acquiring a plurality of signal points, wherein the plurality of signal points is constructed by phase values of different point positions of the modulation signal;
acquiring demodulation values of each of the plurality of signal points according to a current signal point, a previous signal point, and a predefined demodulation algorithm; and
acquiring a demodulation signal according to the demodulation values.

2. The demodulation method of claim 1, wherein the acquiring the demodulation value of the current signal point of one of the plurality of signal points according to the current signal point, the previous signal point, and the predefined demodulation algorithm comprises:
acquiring an angle between the previous signal point and an axis of an original coordinate system;
forming a new coordinate system by rotating the original coordinate system according to the angle;
acquiring coordinate of the current signal point in the new coordinate system; and
acquiring the demodulation value of the current signal point based on the coordinates of the current signal point in the new coordinate system.

3. The demodulation method of claim 2, wherein the axis in the original coordinate system is an I axis.

4. The demodulation method of claim 3, wherein the previous signal point is located on a new axis of the new coordinate system.

5. The demodulation method of claim 4, wherein the acquiring the demodulation value of the current signal point based on the coordinates of the current signal point in the new coordinate system comprises:
acquiring a first absolute value of the first coordinate value and a second absolute value of a second coordinate value of the current signal point;
confirming the demodulation value to be a first predefined angle when it is determined that the first absolute value is greater than the second absolute value, and the second coordinate value is a positive value;
confirming the demodulation value to be a second predefined angle when it is determined that the first absolute value is greater than the second absolute value, and the second coordinate value is a negative value;
confirming the demodulation value to be a third predefined angle when it is determined that the first absolute value is less than the second absolute value, and the second coordinate value is a positive value; and
confirming the demodulation value to be a fourth predefined angle when it is determined that the first absolute value is less than the second absolute value, and the second coordinate value is a negative value.

6. The demodulation method of claim 1, wherein the acquiring the demodulation value of the current signal point of one of the plurality of signal points according to the current signal point, the previous signal point, and a predefined demodulation algorithm comprises:
acquiring four reference points by rotating the previous signal point at a predefined angle in the original coordinate system;
calculating distances between the current signal point and the four reference points respectively; and
acquiring the demodulation value according to a minimum distance of the distances and the predefined angle.

7. The demodulation method of claim 1, wherein the acquiring the demodulation value of the current signal point of one of the plurality of signal points according to the current signal point, the previous signal point, and a predefined demodulation algorithm comprises:
calculating a first angle between the previous signal point and the axis in the original coordinate axis;
calculating a second angle between the current signal point and the axis in the original coordinate axis;
acquiring a vector angle between the previous signal point and the current point signal according to the first angle and the second angle; and
acquiring the demodulation value according to the vector angle.

8. The demodulation method of claim 1, wherein the acquiring the demodulation value of the current signal point of one of the plurality of signal points according to the current signal point, the previous signal point, and a predefined demodulation algorithm comprises:
acquiring a cosine value of the angle between the previous signal point and the current signal point by a vector product algorithm;
acquiring a sine value of the angle between the current signal point and the current signal point by the vector product algorithm; and
acquiring the modulation value according to the cosine value and the sine value of the angle between the current signal point and the current signal point.

9. A demodulation system comprises:
a phase extraction circuitry, configured to receive a modulation signal, output a plurality of signal points, wherein the plurality of signal points is constructed by phase values of different point positions of the modulation signal; and
a demodulation circuitry, configured to acquire demodulation values of each of the plurality of signal points according to the current signal point, a previous signal point, and a predefined demodulation algorithm, and acquire a demodulation signal according to the demodulation values.

10. The demodulation system of claim 9, wherein the demodulation circuitry further acquires an angle between the previous signal point and an axis of an original coordinate system, forms a new coordinate system by rotating the original coordinate system according to the angle, acquires coordinate of the current signal point in the new coordinate system, and acquires the demodulation value of the current signal point based on the coordinates of the current signal point in the new coordinate system.

11. The demodulation system of claim 10, wherein the demodulation circuitry further acquires a first absolute value of the first coordinate value and a second absolute value of a second coordinate value of the current signal point; when it is determined that the first absolute value is greater than the second absolute value, and the second coordinate value is a positive value, the demodulation value is confirmed to be a first predefined angle; when it is determined that the first absolute value is greater than the second absolute value, and the second coordinate value is a negative value, the demodulation value is confirmed to be a second predefined angle; when it is determined that the first absolute value is less than the second absolute value, and the second coordinate value is a positive value, the demodulation value is confirmed to be a third predefined angle; when it is determined that the first absolute value is less than the second absolute value, and the second coordinate value is a negative value, the demodulation value is confirmed to be a fourth predefined angle.

12. The demodulation system of claim 9, wherein the demodulation circuitry further acquiring four reference points by rotating the previous signal point at a predefined angle in the original coordinate system; the demodulation circuitry further calculates distances between the current signal point and the four reference points respectively; the demodulation circuitry further acquires the demodulation value according to a minimum distance of the distances and the predefined angle.

13. The demodulation system of claim 9, wherein the demodulation circuitry further calculating a first angle between the previous signal point and the axis in the original coordinate axis; the demodulation circuitry further calculates a second angle between the current signal point and the axis in the original coordinate axis; the demodulation circuitry further acquires a vector angle between the previous signal point and the current point signal according to the first angle and the second angle; the demodulation circuitry further acquires the demodulation value according to the vector angle.

14. The demodulation system of claim 9, wherein the demodulation circuitry further acquire a cosine value of the angle between the previous signal point and the current signal point by a vector product algorithm; the demodulation circuitry further acquires a sine value of the angle between the current signal point and the current signal point by the vector product algorithm; the demodulation circuitry further acquires the modulation value according to the cosine value and the sine value of the angle between the current signal point and the current signal point.

15. A communication device comprises a demodulation system; wherein the demodulation system comprises a phase extraction circuitry and a demodulation circuitry; wherein the phase extraction circuitry receives a modulation signal, outputs a plurality of signal points; the signals points are constructed by phase values of different point positions of the modulation signal; the demodulation circuitry acquires demodulation values of each of the plurality of signal points according to the current signal point, a previous signal point, and a predefined demodulation algorithm; the demodulation circuitry further acquires a demodulation signal according to the demodulation values.

16. The communication device of claim 15, wherein the demodulation circuitry further acquires an angle between the previous signal point and an axis of an original coordinate system, forms a new coordinate system by rotating the original coordinate system according to the angle, acquires coordinate of the current signal point in the new coordinate system, and acquires the demodulation value of the current signal point based on the coordinates of the current signal point in the new coordinate system.

17. The communication device of claim 16, wherein the demodulation circuitry further acquires a first absolute value of a first coordinate value and a second absolute value of a second coordinate value of the current signal point; when it is determined that the first absolute value is greater than the second absolute value, and the second coordinate value is a positive value, the demodulation value is confirmed to be a first predefined angle; when it is determined that the first absolute value is greater than the second absolute value, and the second coordinate value is a negative value, the demodulation value is confirmed to be a second predefined angle; when it is determined that the first absolute value is less than the second absolute value, and the second coordinate value is a positive value, the demodulation value is confirmed to be a third predefined angle; when it is determined that the first absolute value is less than the second absolute value, and the second coordinate value is a negative value, the demodulation value is confirmed to be a fourth predefined angle.

18. The communication device of claim 15, wherein the demodulation circuitry further acquiring four reference points by rotating the previous signal point at a predefined angle in the original coordinate system; the demodulation circuitry further calculates distances between the current signal point and the four reference points respectively; the demodulation circuitry further acquires the demodulation value according to a minimum distance of the distances and the predefined angle.

19. The communication device of claim 15, wherein the demodulation circuitry further calculating a first angle between the previous signal point and the axis in the original coordinate axis; the demodulation circuitry further calculates a second angle between the current signal point and the axis in the original coordinate axis; the demodulation circuitry further acquires a vector angle between the previous signal point and the current point signal according to the first angle and the second angle; the demodulation circuitry further acquires the demodulation value according to the vector angle.

20. The communication device of claim 15, wherein the demodulation circuitry further acquire a cosine value of the angle between the previous signal point and the current signal point by a vector product algorithm; the demodulation circuitry further acquires a sine value of the angle between the current signal point and the current signal point by the vector product algorithm; the demodulation circuitry further acquires the modulation value according to the cosine value and the sine value of the angle between the current signal point and the current signal point.
